(19) United States
(12) Patent Application Publication
(10) Pub. No.: US 2006/0154119 A1
(43) Pub. Date: Jul. 13, 2006

(54) Method for regeneration of performance in a fuel cell

(76) Inventors: Sridhar Makam P. Kumar, Hockessin, DE (US); Tuyu Xie, Kingston, (CA); Mohamed Abdou, Chadds Ford, PA (US); Peter Andrin, Napanee (CA)

Correspondence Address: E. I. Du Pont De Nemours and Company, Legal Patent Records Center, 4417 Lancaster Pike, Wilmington, DE, 19805, US

(21) Appl. No.: 10/527,501

(22) PCT Filed: Sep. 30, 2003
(86) PCT No.: PCT/US03/31236

§ 371 Date: Feb. 10, 2006

Related U.S. Application Data
(60) Provisional application No. 60/414,848, filed on Sep. 30, 2002.

(51) Int. Cl. H01M 8/00

(52) U.S. Cl. 429/13

(57) ABSTRACT

A process for improved performance in a fuel cell or stack of fuel cells wherein the fuel cell has a cathode, an anode, an anode chamber, a cathode chamber, a fuel comprising an anolyte that flows through the cell, and a catholyte gas, and wherein the fuel cell is connected to an external load, and wherein the process comprises taking the load off the cell, and cycling between a minimum voltage and about 50% of the maximum voltage drawn from the fuel cell until a maximum current is reached, or a minimum load and about 50% of the maximum load until a maximum voltage is reached. Fuel cell performance is further enhanced by purging.

### FIELD OF THE INVENTION

This invention relates to the regeneration of performance of a fuel cell and stack thereof, and more particularly to methods for regeneration of a direct feed fuel cell, such as a direct methanol fuel cell (DMFC), and stack thereof.

### BACKGROUND OF THE INVENTION

Solid polymer electrolyte fuel cells employ a membrane comprising a solid polymer electrolyte disposed between two porous electron and proton conductive electrodes, the anode and the cathode compartments. The anode and cathode compartments include catalyst layers, gas diffusion layers, and electron conductive flow field plates. Fuel is fed into the anode flow field, diffusing onto the porous catalyst layer, and is oxidized to produce electrons, protons, and CO₂ as a by product when methanol aqueous solution is used as fuel. The polymer electrolyte membrane is proton conductive allowing the protons to migrate towards the cathode. At the same time, oxidant is fed into the cathode compartment wherein the oxidant diffuses onto the porous cathode catalyst layer and reacts with the protons and electrons, producing water as a by-product. The electrons travel from the anode to the cathode through an external circuit, thus producing the desired electrical power.

In stationary applications, fuel cell systems may be required to operate continuously for a period of time. However, in portable or traction power applications, fuel cell systems may be subjected to frequent start-up and shut down cycles. In either case, the fuel cell is expected to provide a reliable power output under specified conditions. Unfortunately, the power output of the fuel cell decreases with operation time under the same operating conditions. For example, fuel cell or stack voltage decays with time at a given operating current density, or vice versa. This cell or stack voltage decay obviously affects overall fuel cell efficiency. More importantly, it may limit fuel cell applications. Therefore, the recovery of fuel cell performance after a period of operation or bringing a fuel cell to a starting up condition after a period of operation is very important in a fuel cell application.

A need exists for a method for regeneration of performance of a fuel cell, typically a direct feed fuel cell, after a period of operation and a method for start up of a fuel cell system after a period of operation.

### SUMMARY OF THE INVENTION

In a first aspect, the invention provides a process for improved performance in at least one fuel cell comprising a cathode, an anode, an anode chamber, a cathode chamber, a fuel comprising an anolyte that flows through the cell, and a catholyte gas, wherein the fuel cell is connected to an external load, and wherein the process comprises:
(a1) taking the load off the fuel cell; and either
(a2) cycling between a minimum voltage, which is defined as about 0.1 to about 30% of the maximum voltage (wherein maximum voltage is defined as the voltage for cell/stack when there is substantially no load being drawn from a healthy fuel cell, i.e. a cell that does not require regeneration), and at least about 50% of the maximum voltage, typically about 60 to about 90% of the maximum voltage, and more typically about 90 to about 100% of the maximum voltage, until a maximum current is reached, or
(a3) cycling between a minimum load, which is defined as about 0 to about 5% of the maximum load, and at least about 50% of the maximum load, typically about 60 to about 90% of the maximum load, and more typically about 90 to about 100% of the maximum load, until a maximum voltage is reached.

In the first aspect, the invention further provides a process wherein before step (a2) or (a3), the process further comprises:
(b) clearing the fuel cell of any liquid present therein to achieve a resistance of at least about 10% higher, more typically at least about 20% higher, and still more typically about 100 to about 500% higher, than the value before clearing the cell of any liquid; and
(c) starting the flow of anolyte through the fuel cell.

### BRIEF DESCRIPTION OF THE DRAWINGS

FIG. 1 is a schematic illustration of a single cell assembly.

FIG. 2 is a schematic illustration of a typical DMFC test station.

FIG. 2A illustrates the regeneration of long term performance of a DMFC with voltage cycling.

FIG. 3 is a graph showing the effect of room temperature voltage cycling on the performance of a DMFC.

FIG. 4 is a graph showing the optimum IV curve from FIG. 3 after voltage cycling, and the IV curve for said cell after 80° C. treatment.

FIG. 5 is a graph showing the cell voltage of a DMFC and its AC Impedence varying with time during a regeneration procedure.

FIG. 6 illustrates the advantages and effectiveness of the regeneration procedure on the long-term performance of a DMFC.

FIG. 7 is a graph showing stack performance regeneration by a combination of purge and toggle operations.

### DETAILED DESCRIPTION OF THE INVENTION

A process is provided for improved performance in at least one fuel cell comprising a cathode, an anode, a fuel comprising an anolyte that flows through the cell, and a catholyte gas, wherein the fuel cell is connected to an external load, and wherein the process comprises cycling between a minimum voltage, which is defined as about 0.1 to about 30% of the maximum voltage (wherein maximum voltage is defined as the voltage for cell/stack when there is substantially no load being drawn from a healthy fuel cell, i.e. a cell that does not require regeneration), and at least about 50% of the maximum voltage, typically about 60 to about 90% of the maximum voltage, and more typically about 90 to about 100% of the maximum voltage, until a maximum current is reached. Alternately, cycling between a minimum load, which is defined as about 0 to about 5% of the maximum load, and at least about 50% of the maximum load, typically about 60 to about 90% of the maximum load, and more typically about 90 to about 100% of the maximum load, until a maximum voltage is reached.

The fuel cell may be a direct feed fuel cell, wherein the fuel is in the liquid or vapor phase. Some suitable fuels include alcohols such as methanol and ethanol; ethers such as diethyl ether, etc.

For the purpose of this application, the term “anode” is used to describe the component of the fuel cell comprising the anode flow field plate, anode gas diffusion layer and anode catalyst layer. The term “cathode” is used to describe the component of the fuel cell comprising the cathode flow field plate, cathode gas diffusion layer and cathode catalyst layer.

The term “stack” refers to a fuel cell stack comprising a series of fuel cells functioning in tandem electrically.

Fuel Cell:

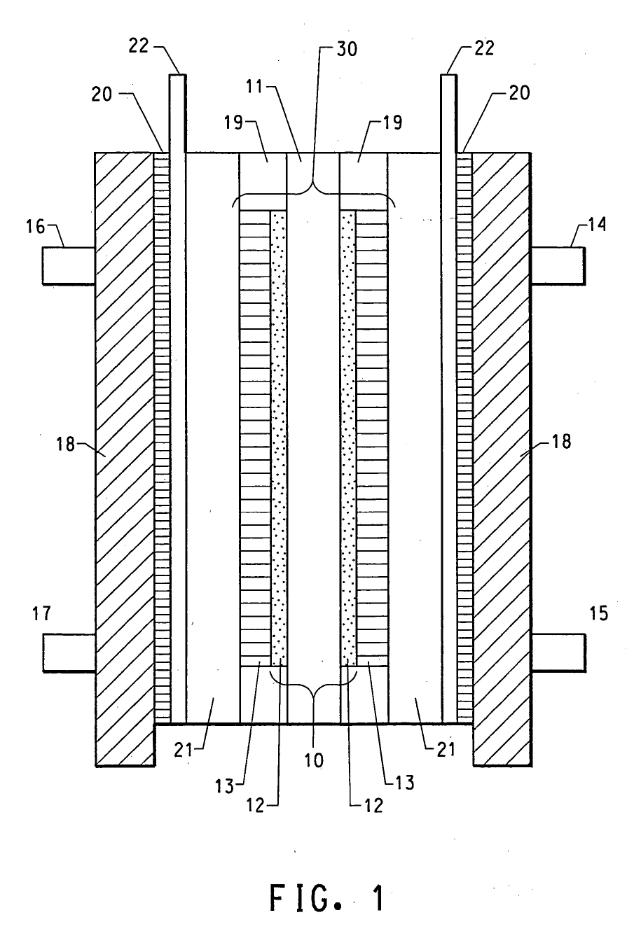

FIG. 1 schematically illustrates a single cell assembly. As shown in FIG. 1, the MEA (30) comprised a catalyst coated membrane, (CCM) (10) sandwiched between two sheets of the gas diffusion backing, (GDB) (13). The anode and cathode gas diffusion backings (13) may comprise carbon paper or cloth and typically a fluorinated polymeric surface-treating agent, although other surface treatments may be used. A microporous layer or layers such as those manufactured by E-Tek Inc., Natick, Mass. may also be present in the cathode gas diffusion backing wherein the microporous layer may typically be disposed toward the cathode catalyst. A glass fiber reinforced silicone rubber gasket (19), for example (Furan—Type 1007, obtained from Stockwell Rubber Company), cut to shape to cover the exposed area of the membrane of the CCM, may be placed on either side of the CCM/GDB assembly (taking care to avoid overlapping of the GDB and the gasket material). The entire sandwich assembly may be assembled between the anode and cathode flow field graphite plates (21). One such 25 cm² standard single cell assembly may be obtained from Fuel Cell Technologies Inc., Los Alamos, N. Mex. The cell shown in FIG. 1 may also be equipped with anode inlet (14), anode outlet (15), catholyte gas inlet (16), catholyte gas outlet (17), aluminum end blocks (18), tied together with tie rods (not shown), electrically insulating layer, (20), and gold plated current collectors, (22).Bolts on the outer plates (not shown) of the single cell assembly may be provided and tightened with a torque wrench to a torgue of 1.5 ft. lb.

A characteristic of liquid feed fuel cells, and in particular direct methanol fuel cells, using a solid polymer electrolyte membrane is that the liquid feed, e.g. aqueous methanol solution, is directly used as fuel. Aqueous methanol solution is fed into the anode of the fuel cell. Air or oxygen is fed into the cathode of the fuel cell. In a DMFC operation, both methanol and water will transport through the proton conductive membrane from the anode to the cathode by both diffusion and osmotic drag. In addition to water crossover, water is also generated at the cathode as a by-product. Therefore, the cathode electrode could be flooded with water if the water removal rate is smaller than the water generation rate at the cathode.

It is desirable to have a stable power output at given fuel cell operating conditions. Unfortunately, fuel cell power output decays with operating time while other operating conditions are kept the same. Because of this voltage decay, a DMFC stack may not be able to provide a desirable power output after a period of operation. Performance decay is an important issue in a DMFC application.

The factors causing the voltage decay may be very complex and some factors are outlined below. It may be one of the following factors or the combination of the following factors:

(1). Catalyst degradation at the anode;

(2). Catalyst degradation at the cathode;

(3). Effect of impurities from the feeds and from the materials of fuel cell structure;

(4). Deterioration of materials used for the stack leading to increase in resistance;

(5). Accumulation of water at the cathode electrode;

(6). Accumulation of CO₂ at the anode electrode and the diffusion layer;

(7). Accumulation of CO at the anode electrode;

(8). Other causes;

(9). Combination of the factors above.

Factors (1) to (4) may cause physical damage to the fuel cell stack, that is permanent decay of the fuel cell stack, whereas factors (5) to (7) are the effects caused by the operating conditions for a given fuel cell system, that result in a temporary decay. This invention discloses a method to recover this temporary decay for given fuel cells and stack designs and operating conditions.

Process for Regeneration:

The following steps may be performed to regenerate a fuel cell:

To start with the cell was brought to an open circuit, i.e., the load on the cell was taken out. For example, a cell that has been operated for a period of time may have a voltage or power output about 5% lower than the desired value. The cell needing regeneration was then cycled between a minimum voltage and at least about 50% of the maximum voltage, typically about 60 to about 90% of the maximum voltage, and more typically about 90 to about 100% of the maximum voltage, a number of times until a maximum current was reached, e.g. about 1 to about 20 times, more typically about 6 to about 10 times, with the anode and cathode flow continuing. For example, cycling may occur between the open circuit voltage (OCV) and 0.2V. Minimum voltage is defined, as about 0.1 to about 30% of the maximum voltage, wherein maximum voltage is defined as the voltage for cell/stack when there is no load being drawn.

Alternately, the load on the fuel cell may be cycled between a minimum load and at least about 50% of the maximum load, typically about 60 to about 90% of the maximum load, and more typically about 90 to about 100% of the maximum load, until a maximum voltage is reached. For example, this includes cycling between no current being drawn from the cell/stack and the rated maximum current density of the cell/stack, until a maximum voltage is reached. Cycling may occur about 1 to about 20 times, more typically about 6 to about about 10 times. Minimum load is defined as about 0 to about 5% of the maximum load. The load was again applied to the cell and the voltage monitored with time.

In a second embodiment, the following steps may be performed to regenerate a fuel cell: To start with the cell was brought to an open circuit, i.e., the load on the cell was taken out. For example, a cell may have a voltage or power output about 5% lower than the desired value. Optionally, an impedence meter may be connected across a cell needing regeneration wherein the drop in power output was dependent on the end use application. This was done under load (at the desired current density) to measure the cell resistance (both when on load and when on open circuit). The flow of anolyte such as a methanol solution, an ethanol solution, etc., was stopped. The anolyte temperature was dependent on the power output and other operating conditions for the cell. The catholyte gas, e.g. air, flow through the cell was continued throughout the process. Optionally, the flow of catholyte gas may be interrupted. The resistance of the cell may be closely monitored. After a certain period of time, the cell resistance slowly crept up and increased to very high values. Clearing the fuel cell of any liquid present therein results in a resistance of at least about 10% higher, more typically at least about 20% higher, and still more typically about 100 to about 500% higher than the value before clearing the cell of any liquid. Optionally, at this stage, the anode side was purged with air, nitrogen or exhaust from the cathode compartment. The cell was left under these conditions for a given period of time and then the anolyte flow through the cell was turned on, wherein the anolyte was at the desired temperature. Optionally, the desired temperature may be achieved using a pre-heater. The resistance of the cell may be monitored and the cell was cycled between no load and full load, for example, between open circuit voltage (OCV) and 0.2V, until the resistance dropped to values similar to those at the start of the regeneration process. The cell was then set at the given load and operation of the cell was resumed.

Following such a sequence of steps results in considerable improvement in performance of the cell after regeneration, in terms of both the power output and the rate of drop in voltage with time. Improved performance in the form of cell activation may also be further achieved using the voltage cycling steps until a maximum current was achieved.

In a separate embodiment, in addition to the above steps, the cathode was purged using air or nitrogen at open circuit condition of the stack after the stack was operated for a period of time. The performance of cell/stack can be further recovered by purging the cathode compartment when the cell/stack is at open circuit and anode fuel feed is turned off. The cathode chamber is purged with air, nitrogen or exhaust from the cathode compartment for at least about 10 seconds, typically about 30 seconds to about 5 minutes.

In addition to the cycling steps described above, a more effective method to recover the temporary decay of cell/stack performance after a period of operation was to turn off the load of the cell/stack; turn off the fuel supply to the anode; and purge the anode compartment using the same air stream that was used for the cathode feeding. Nitrogen or the exhaust from the cathode compartment may also be used for the purging step. After purging the anode for a short period of time, the cathode compartment was purged using the same air steam for the cathode feeding or nitrogen. After the purging operation, the cell/stack was subjected to normal operation. It was found that the temporary decay of the cell/stack was fully recovered. In the above method, the cell/stack performance may be fully recovered by purging the anode, without the cathode compartment being purged.

The recovery of cell/stack performance was independent of oxygen concentration when purging the anode, i.e., using either air, nitrogen or the exhaust from the cathode compartment can obtain the same result of cell/stack performance recovery.

In a DMFC application, any purging required is a parasitic energy loss. Therefore, the shorter the duration of purging, the better. Based on the stack design used for this invention, a typical time range for anode purging is about 0.01 to about 30 minutes, typically about 0.1 to about 30 minutes. A more typical time range is 1 to 15 minutes. A typical time range for the cathode purge is less than 5 minutes. A typical purging temperature is the cell/stack operating temperature. The cell/stack temperature could decrease during the purge operation.

In a multiple stack application, in order to maintain continuous power output, regeneration operations can be scheduled so that some stacks are in normal operation and others are being regenerated using the method above.

The regeneration procedures described above may be performed right after the stack is shut down or at the start up period. Because the purging operation is more effective at relatively high temperatures, it is preferred to perform the regeneration operations at the shut down process.

### EXAMPLES

CCM Preparation Procedure:

The cathode catalyst dispersion was prepared in a Eiger® bead mill, manufactured by (Eiger Machinery Inc., Greybrlake, IL 60030), containing 80 ml 1.0-1.25 zirconia grinding media. 13.5 grams platinum black catalyst powder (catalyst grade (obtained from Colonial Metals, Elkton, Md.) and 42.8 grams of the 3.5wt % Nafioh® solution (the polymer resin used in such a solution was typically of 930EW polymer and was in the sulfonyl fluoride form) were mixed and charged into the mill and dispersed for 2 hours. Material was withdrawn from the mill and particle size measured. The ink was tested to ensure that the particle size was under 1 micron and the % solids in the range 13.56-13.8. The catalyst decal was prepared by drawing down the catalyst ink to a dimension of 5 cm×5 cm (to give a total area of 25 cm²) on a 10 cm×10cm piece of 3 mil thick Kapton® polyimide film manufactured by E.I. du Pont de Nemours & Co., Wilmington, Del. A wet coating thickness of 5 mil (125 microns) typically resulted in a catalyst loading of 4 to 5 mgPt/cm² in the final CCM. Anode decals were prepared using a procedure similar to that described above, except that in the catalyst dispersion, the platinum black catalyst was replaced by platinum/ruthenium black catalyst powder (obtained from Johnson Mathey Inc.). The CCM is prepared by a decal transfer method. A piece of wet Nafion® N117 membrane (4″×4″) in the H⁺ form, manufactured by DuPont, was used for CCM preparation. The membrane was sandwiched between two anode and cathode catalyst coated decals. Care was taken to ensure that the coatings on the two decals were registered with each other and were positioned facing the membrane. The entire assembly was introduced between two pre-heated (to 145C) 8″×8″ plates of a hydraulic press and the plates of the press were brought together without wasting much time until a pressure of 5000 lbs. is reached. The sandwich assembly was kept under pressure for ˜2 mins. and then the press was cooled for ˜2 mins. (viz., till it reached a temperature of <60° C.) under same pressure. Then the assembly was removed from the press and the Kapton® films were slowly peeled off from the top of the membrane showing that the catalyst coating had been transferred to the membrane. The CCM was immersed in a tray of water to ensure that the membrane was completely wet, and carefully transferred to a zipper bag for storage and future use.

Chemical Treatment of CCMs

The CCMs were chemically treated in order to convert the ionomer in the catalyst layer from the —SO₂F form to the —SO₃H form. This requires a hydrolysis treatment followed by an acid exchange procedure. The hydrolysis of the CCMs was carried out in a 30-wt % NaOH solution at 80° C. for 30 min. The CCM's were placed between Teflon® mesh, manufactured by DuPont, and placed in the solution. The solution was stirred to assure uniform hydrolyses. After 30 minutes in the bath, the CCM's were removed and rinsed completely with fresh Dl water to remove all the NaOH.

Acid exchange of the CCMs that were hydrolyzed in the previous step was done in 15-wt % Nitric Acid Solution at a bath temperature of 65° C. for 45 minutes. The solution was stirred to assure uniform acid exchange. This procedure was repeated in a second bath containing 15-wt % Nitric acid solution at 65° C. and for 45 minutes.

The CCMs were then rinsed in flowing DI water for 15 minutes at room temperature to ensure removal of all the residual acid. They were then packaged wet and labeled. The CCM (10) comprised a Nafion® perfluorinated ion exchange membrane (11); and electrodes (12), prepared from a platinum catalyst and Nafion® binder on the anode side, and a platinum/ruthenium catalyst and Nafion® binder on the cathode side.

Fuel Cell Performance Evaluation Procedure:

FIG. 1 schematically illustrates a single cell assembly. Fuel cell test measurements were made employing a single cell test assembly obtained from Fuel Cell Technologies Inc, N. Mex. As shown in FIG. 1, the MEA (30) comprised the CCM (10) sandwiched between two sheets of the GDB (13) (taking care to ensure that the GDB covered the catalyst coated area on the CCM). The anode gas diffusion backing (13) comprised carbon cloth and a fluorinated polymeric surface-treating agent. The cathode diffusion backing comprised an ELAT with a single microporous layer from E-Tek Inc., Natick, Mass. The microporous layer was disposed toward the cathode catalyst. A glass fiber reinforced silicone rubber gasket (19) (Furan®—Type 1007, obtained from Stockwell Rubber Company, Philadelphia, Pa.), cut to shape to cover the exposed area of the membrane of the CCM, was placed on either side of the CCM/GDB assembly (taking care to avoid overlapping of the GDB and the gasket material). The entire sandwich assembly was assembled between the anode and cathode flow field graphite plates (21) of a 25 cm² standard single cell assembly (obtained from Fuel Cell Technologies Inc., Los Alamos, N. Mex.). The test assembly shown in FIG. 1 was also equipped with anode inlet (14), anode outlet (15), catholyte gas inlet (16), catholyte gas outlet (17), aluminum end blocks (18), tied together with tie rods (not shown), electrically insulating layer, (20), and gold plated current collectors, (22). The bolts on the outer plates (not shown) of the single cell assembly were tightened with a torque wrench to a force of 1.5 ft. lb.

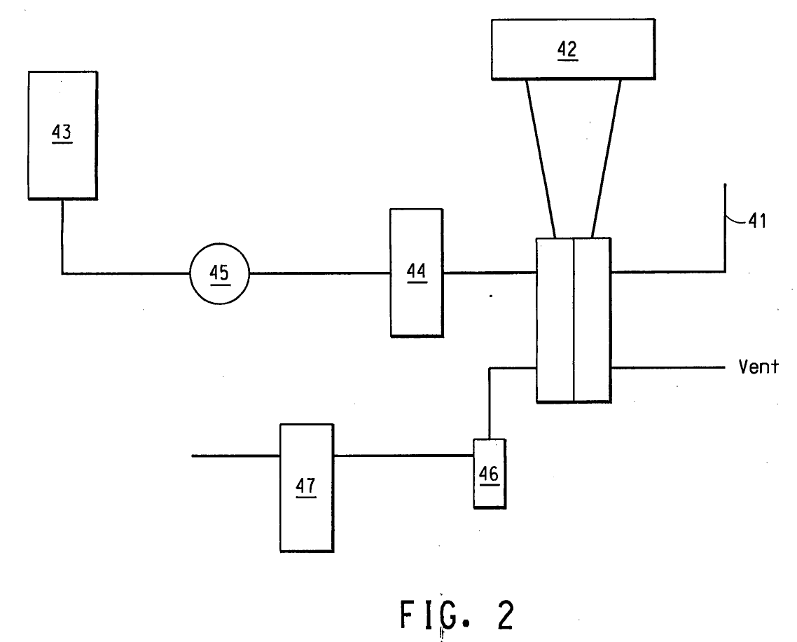

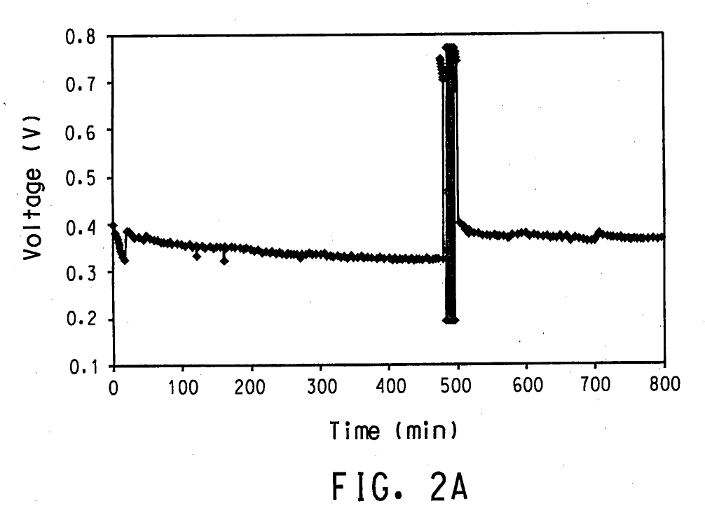

The single cell assembly was then connected to the fuel cell test station (a schematic of which is shown in the FIG. 2. The components in a test station include a supply of air for use as catholyte gas (41); a load box to regulate the power output from the fuel cell (42); a MeOH solution tank to hold the feed anolyte solution (43); a heater to pre-heat the MeOH solution before it enters the fuel cell (44); a liquid pump to feed the anolyte solution to the fuel cell at the desired flow rate (45); a condenser to cool the anolyte exit from the cell from the cell temperature to room temperature (46) and a collection bottle to collect the spent anolyte solution (47)

With the cell at room temperature, 1M MeOH solution and air were introduced into the anode and cathode compartments through inlets (14) and (16) of the cell at flow rates of 25 cc/min and 3 SLPM (standard liters per minute), respectively. The gas streams were humidified with water vapor before they entered the cell. The temperature of the single cell was slowly raised till it reached 80° C. Typically, a current-voltage polarization curve was recorded. This comprised of recording the current output from the cell as the voltage was stepped down in 50 mV steps starting from the open circuit voltage (OCV) down to 0.15 V and back up to OCV. The voltage was held constant in each step for 20 sec to allow for the current output from the cell to stabilize.

### Example 1

A standard 25 cm² CCM prepared as described above was assembled in a cell. The cell was heated to a temperature of 60° C. 1M MeOH solution was used as the anolyte and a flow rate of 2 ml/min. Air was used as the oxidant at 100 sccm. The cell was tested at a constant load of 50 mA/cm² and the cell voltage was monitored with time. After 480 mins of testing under these conditions, the cell voltage had dropped by more than 15% from the initial value (dropped from ˜0.4V to 0.33V). At this point, the load on the cell was taken out and cell was cycled between OCV and 0.2V eight times with the anode and cathode flows continuing. After this voltage cycling, the load (of 50 mA/cm2) was again applied to the cell and the voltage was monitored with time. The results are presented in FIG. 2A. Immediately following the voltage cycling sequence, the cell voltage (under the constant load) returned to 0.4V (the value at the beginning of the test) proving the effectiveness of the voltage cycling sequence in regenerating the lost fuel cell performance.

### Example 2

A standard 25 cm² CCM prepared as described above was loaded in a cell and cycled at room temperature (RT) between 0.905V and 0.005V at a rate of 20 mV/sec (with air at 3 SLPM and 1M MeOH flow of 25 cc/min). The cycling was to decrease the voltage from 0.905 to 0.005V and back to 0.905V at the stated rate. A total of 10 cycles was performed. Then a standard IV curve was recorded on the sample at RT (0.8V to 0.1V and back to 0.8 v in 50 mV steps and 20 sec at each step). The temperature of the cell was then raised to 80° C. where a couple of standard IV curves were recorded with air and oxygen. The cell was then cooled to RT and then again an IV curve was recorded under the same conditions as before.

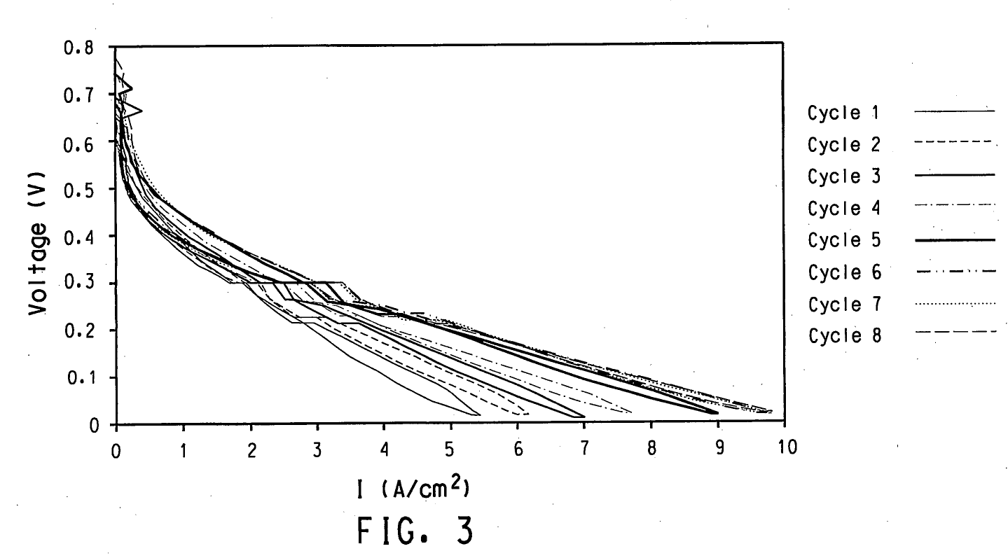

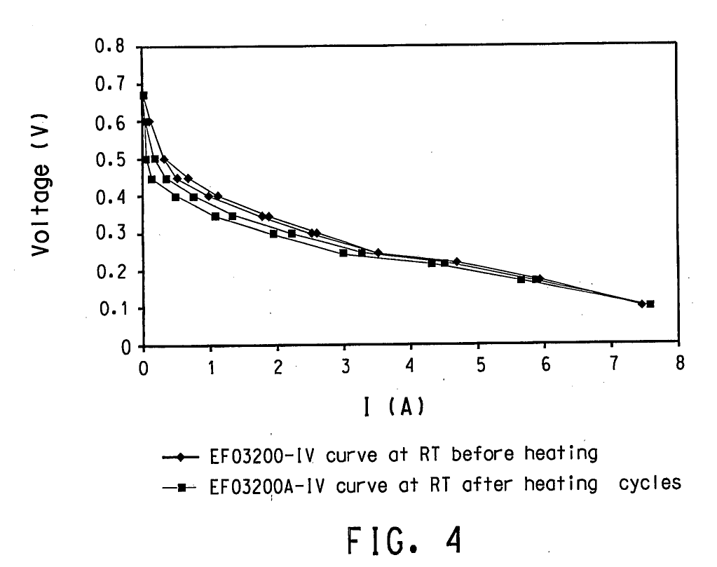

There was a definite improvement in performance upon RT cycling (see FIG. 3) up to 7 cycles. Then the performance remained constant. An attempt was made to verify if high temperature treatment (cycling) of the sample would improve the performance further. But the data indicates that it was not the case. There was no further activation on cycling at high temperature. Results are shown in FIG. 4.

This experiment demonstrated that room temperature activation of fuel cells was achieved by cycling between a maximum voltage and minimum voltage drawn from the fuel cell until a maximum current was reached.

### Example 3

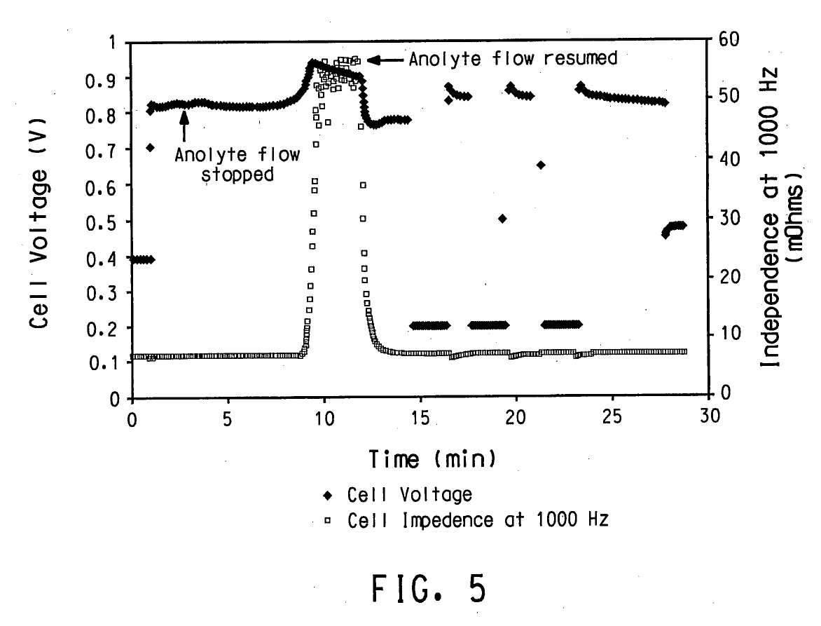

This example shows the regeneration of a fuel cell using the following steps: An impedence meter was connected across a cell needing regeneration and identified in the graph as EO48. The cell had a voltage or power output about 15% lower than the desired value. This was done under load at 200 mA/cm² to measure the cell resistance (both when on load and when on open circuit). The cell resistance was found to be 6.9 mOhm. This was followed by the cell being brought to an open circuit, i.e., the load on the cell was taken out. Next, the flow of anolyte [1M MeOH solution] through the cell was stopped. The flow of catholyte gas, which was air, through the cell was continued throughout the process and the resistance of the cell was closely monitored. After a certain period of time the cell resistance slowly crept up and increased to 55 mOhm and the cell was left under these conditions for 60 seconds. Next, the anolyte [1M MeOH solution] flow through the cell was turned on at a rate 0 f 25 ml/min. The resistance of the cell was monitored and the cell was cycled between open circuit voltage (no load) and 0.2V until the resistance dropped to 7.2 mOhm. The cell was then set at 200 mA/cm² load to return it to normal operation. The results are summarized in FIG. 5.

The process steps outlined above resulted in considerable improvement in performance of the cell, after regeneration as compared to that before regeneration, both in terms of the power output and the rate of drop in voltage with time. This process was repeated after every 36 hours of operation of the under load (of 200 mA/cm2) to regenerate the cell.

### Example 4

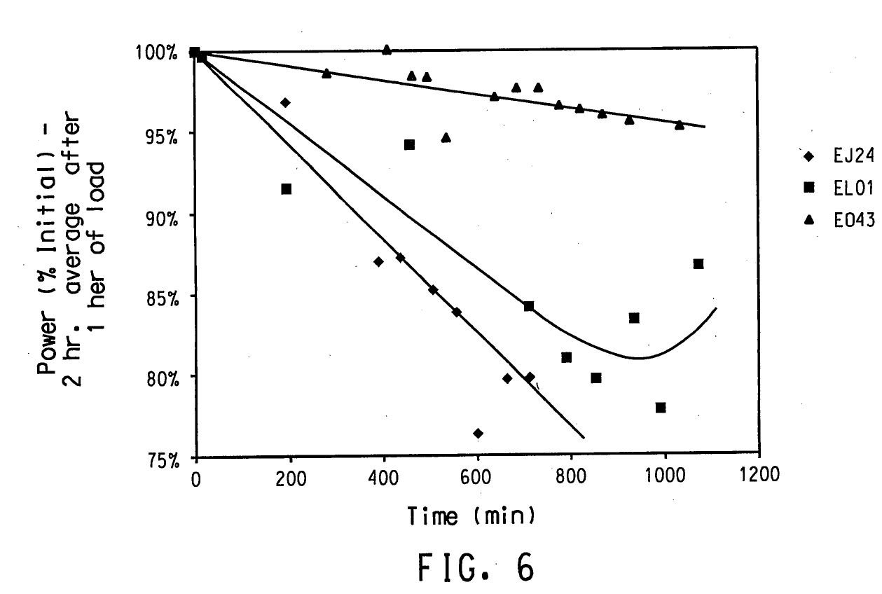

A comparison was made between the performance of two samples that were prepared as described in the CCM Preparation Procedure, one without the regeneration treatment and the other with. The results are shown in FIG. 6. Plotted on the graph was the two-hour average power output that was taken after one hour of operation at load after each regeneration step. This was shown as a percentage of the average initial power output as a function of the time.

The first curve identified as EJ24 was on a cell wherein the regeneration treatment was not used. After each break, the sample was restarted and set to the given experimental conditions. The anolyte and catholyte gas flows were not changed during the break period. The second curve identified as ELO1 was run for ˜900 hrs under conditions similar to EJ24. But at this point, the regeneration treatment described in Example 3 was adopted at each break (i.e., starving the cell of anolyte during the break period at the cell temperature of 80° C. Such a treatment resulted in a significant reversal of the behavior where the power output increased significantly.

### Example 5

Example 3 was repeated with the following exceptions: The sample to be tested was E043. This sample was subjected to the previously outlined regeneration treatment as described in Example 3 right from the start instead of after 900 hours of operation. Care was taken to ensure that the voltage (at a constant load of 0.2 A/cm²) did not drop by more than 20% (of the initial value) at any point of time. As soon as the cell voltage dropped by about 20%, the cell was subjected to the regeneration treatment. The performance of the cell rebounded back significantly and overall performance of the cells was relatively much better than the previous cells (EJ24 and EL01 in FIG. 6).

### Example 6

A DMFC stack comprising 6-fuel cells was used in this example. Each fuel cell included electrodes with active area of 100 cm². The anode catalyst was Pt/Ru alloy, 4 mg/cm², and the cathode catalyst was Pt, 4 mg/cm². Nafion® 117 (DuPont) was used as proton conductive membrane and electron conductive carbon cloth was used as the diffusion layers for both the anode and cathode. Conductive plates with multiple flow channels were used as current collecting plates for the anode and cathode flow field plates (21).

The DMFC stack was operated at the following conditions in this example:

| | |
|---|---|
| Methanol solution feed rate: | 300 cc/min |
| Methanol concentration: | 3.2 wt % |
| Air feed rate: | 15 SLPM |
| Stack temperature: | 80° C. |
| Current density: | 0.2 A/cm² |

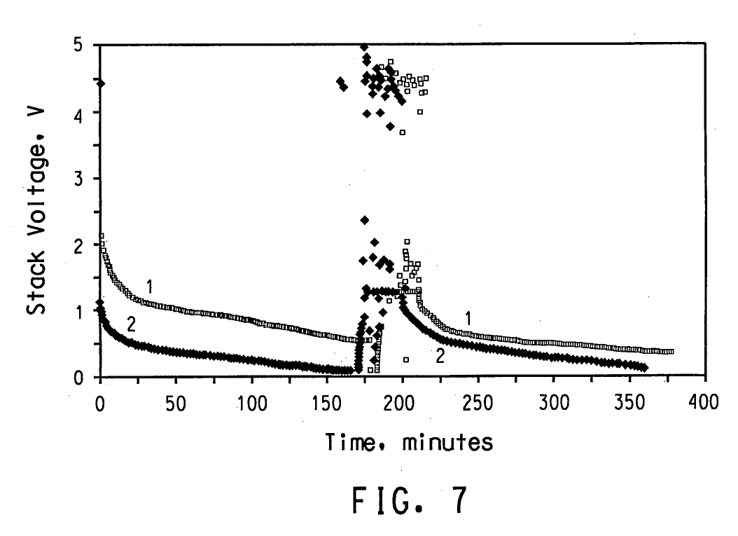

The stack was operated with the above conditions and at the current density of 0.2 A/cm² for 3 hours. Then, the load was turned off and fuel feed to the anode was also turned off. The anode and cathode of stack were purged using air with feed rate of 30 SLPM for 5 minutes each. After the purge, the stack was operated with on/off load for a period of time. The stack was operated off load for 20 seconds and at 1.2V for 1 minute and the cycle was repeated 15 times (toggle operation). After operation at 0.2 A/cm² for 2 hrs and 50 minutes, the stack was subjected to the purge and toggle operations. The performance of the stack was recovered and was better than the starting point where purge and toggle operation were not performed. The results of above operation are shown in FIG. 7. Curve 1 represents the voltage at the start and after the toggle operation in the fuel cell regeneration process. When the stack was operated at 0.2 A/cm² for 3 hrs, the stack was purged and toggled as described above and its operation was continued at 0.2 A/cm2. The performance of the stack was recovered after the regeneration operation. Curve 2 represents the voltage changes between the fuel cell stack that was not purged at startup and after the purge and the toggle operations.

What is claimed is:

1. A process for improved performance in at least one fuel cell comprising a cathode, an anode, an anode chamber, a cathode chamber, a liquid comprising an anolyte that flows through the cell, and a catholyte gas, wherein the fuel cell is connected to an external load, and wherein the process comprises:
(a1) taking the load off the fuel cell; and
(a2) cycling between a minimum voltage and at least about 50% of a maximum voltage drawn from the fuel cell until a maximum current is reached; or
(a3) cycling between a minimum load, and at least about 50% of the maximum load, until a maximum voltage is reached.

2. The process of claim 1 wherein minimum voltage is about 0.1 to about 30% of the maximum voltage

3. The process of claim 1 wherein cyclying is between a minimum voltage and about 60 to about 90% of the maximum voltage.

4. The process of claim 1 wherein the fuel cell is a direct feed fuel cell.

5. The process of claim 4 wherein the fuel is in the liquid or vapor phase.

6. The process of claim 5 wherein the fuel is an alcohol or an ether.

7. The process of claim 6 wherein the alcohol is methanol or ethanol.

8. The process of claim 6 wherein the ether is diethyl ether.

9. The process of claim 3 wherein cycling is between a minimum voltage and about 90 to about 100% of the maximum voltage.

10. The process of claim 1 wherein minimum load is about 0 to about 5% of the maximum load.

11. The process of claim 1 wherein cyclying is between a minimum load about 60 to about 90% of the maximum load.

12. The process of claim 11 wherein cycling is between a minimum load and about 90 to about 100% of the maximum load.

13. The process of claim I wherein before step (a2) or (a3), the process further comprises:
(b) clearing the fuel cell of any liquid present therein to achieve a resistance of at least about 10% higher than the value before clearing the cell of any liquid; and
(c) starting the flow of anolyte through the fuel cell.

14. The process of claim 13 wherein the clearing of the fuel cell of any liquid present therein is achieved by:
(b1) stopping the flow of anolyte through the fuel cell; and
(b2) providing a continuous flow of catholyte gas through the fuel cell for at least 30 seconds;

15. The process of claim 13 or 14 further comprising:
(d) oxidizing the residual fuel in the fuel cell.

16. The process of claim 15 wherein oxidizing the residual fuel in the fuel cell is achieved by breaking the electrical connection between the cathode and anode.

17. The process of claim 15 wherein oxidizing the residual fuel in the fuel cell is achieved by applying a constant voltage in the range of about 0.005 V to about 0.8 V per cell.

18. The process of claim 13 or 14 wherein before step (c), the anode chamber is purged with air.

19. The process of claim 13 or 14 wherein before step (c), the anode chamber is purged with nitrogen.

20. The process of claim 13 or 14 wherein after step (al) the anode chamber is purged with water.

21. The process of claim 15 wherein before step (c) the anode chamber of is purged with air.

22. The process of claim 13 or 14 wherein the before step (c), the cathode chamber is purged with air.

23. The process of claim 18 wherein the cathode chamber is purged with air.

24. The process of claim 22 wherein the cathode chamber is purged with air for at least 10 seconds.

25. The process of claim 23 wherein the cathode chamber is purged with air for at least 10 seconds.

26. The process of claim 23 wherein the anode chamber is purged with air after the cathode chamber is purged.

27. The process of claim 23 wherein the anode chamber is purged with nitrogen after the cathode chamber is purged.

28. The process of claim 26 wherein the air comprises exhaust air from the cathode chamber.

29. The processes of claim 26 wherein the anode chamber is purged for about 2-15 minutes.

30. The processes of claim 27 wherein the anode chamber is purged for about 2-15 minutes.

31. The processes of claim 30 wherein the anode chamber is purged for about 2-15 minutes.

32. The processes of claim 29, 30 or 31 wherein the anode chamber is purged for about 5-15 minutes.

33. The processes of claim 32, wherein the anode chamber is purged for about 10-15 minutes.

34. The process of claim 1 wherein the resistance reached is at least about 20% higher than the value before clearing the cell of any liquid.

35. The process of claim 34 wherein the resistance reached is about 100 to about 500% higher than the value before clearing the cell of any liquid.

36. The process of claim 1 or 13 wherein fuel cells are in a stack.

37. The process of claim 15 wherein fuel cells are in a stack.
